(19) United States
(12) Patent Application Publication
(10) Pub. No.: US 2026/0245029 A1
(43) Pub. Date: Aug. 20, 2026

(54) Operation Control Apparatus, Operation Control Method, and Operation Control System

(71) Applicant: Hitachi, Ltd., Chiyoda-ku, Tokyo (JP)

(72) Inventors: Kimiyoshi MACHII, Tokyo (JP); Mikio BANDO, Tokyo (JP); Swarn Singh RATHOUR, Tokyo (JP)

(21) Appl. No.: 19/160,099

(22) PCT Filed: Apr. 3, 2024
(86) PCT No.: PCT/JP2024/013840

§ 371 Date: Aug. 27, 2025

(30) Foreign Application Priority Data
May 8, 2023 (JP) 2023-076711

(51) Int. Cl. G06Q 10/083; G08G 5/34; G08G 5/54; G08G 5/57; G08G 5/74

(52) U.S. Cl. CPC G06Q 10/08355; G08G 5/34; G08G 5/54; G08G 5/57; G08G 5/74

(57) ABSTRACT

Provided is a traffic control device capable of realizing safe and efficient transportation and logistics by coordinating flight vehicles and ground vehicles such as public transportation vehicles and vehicles managed by other companies. A traffic control device determines an alternative landing location and a ground vehicle for delivering cargo of a flight vehicle from the alternative landing location to a destination, said determination being made on the basis of self-position information of the flight vehicle, surrounding environment information of the flight vehicle, location information which is information about candidates for the alternative landing location where the flight vehicle will land, flight plan information leading to the destination of the flight vehicle, and ground vehicle information which is information about candidates for the ground vehicle at a transfer destination.

### TECHNICAL FIELD

The present invention relates to an operation control apparatus, an operation control method, and an operation control system that control operation of a flying object and another moving object.

### BACKGROUND ART

In order to implement a small flying object as transport and logistics infrastructure in society, it is hoped that the implementation of a next-generation transport service in coordination with existing ground vehicles will improve the efficiency of movement.

Patent Literature 1 describes a technique for performing control such that a vehicle having a takeoff and landing section where a flying object can take off and land moves to an alternative takeoff and landing site.

According to Patent Literature 1, when it is determined that the flying object cannot land on a takeoff and landing site at a scheduled landing time, an alternative takeoff and landing site on which the flying object can land is determined, the vehicle having the takeoff and landing section where a flying object can take off and land is moved to the alternative takeoff and landing site.

### CITATION LIST

### Patent Literature

Patent Literature 1: Japanese Patent No. 7068386

### SUMMARY OF INVENTION

### Technical Problem

However, the technique described in Patent Literature 1 is a technique for causing the vehicle having the takeoff and landing section to move the flying object such as a drone, and does not describe a technique for causing the flying object to land on the alternative site, and transporting a person and a cargo aboard the flying object from the alternative site to a destination using various moving means.

Therefore, it is not possible to use a vehicle managed by another company and a public transport institution that do not have a takeoff and landing section, making it difficult to appropriately transport a person and a cargo aboard a flying object from the alternative site to the destination.

An object of the present invention is to provide an operation control apparatus, an operation control method, and an operation control system that can implement safe and efficient transport and logistics by coordination of a small flying object with a vehicle managed by another company and a ground vehicle for a public transport institution or the like.

### Solution to Problem

To achieve the above-described object, the present invention is configured as follows.

An operation control apparatus includes a transfer determining unit that determines an alternative landing site and a ground vehicle for transporting a subject carried by a flying object from the alternative landing site to a destination, based on self-location information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination.

In addition, an operation control method in which an operation control apparatus controls flight operation of a flying object includes determining an alternative landing site and a ground vehicle for transporting a subject carried by the flying object from the alternative landing site to a destination, based on self-position information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination.

In addition, an operation control system includes: an operation control apparatus including a transfer determining unit that determines an alternative landing site and a ground vehicle for transporting a subject carried by a flying object from the alternative landing site to a destination, based on self-location information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination, a flight route calculation unit that calculates a flight route for the flying object to land on the alternative landing site, and a route information transmission unit that transmits the flight route to the flight object; and a flying object including an environment information transmission unit that transmits the surrounding environment information to the operation control apparatus, a route information reception unit that receives flight route information from the operation control apparatus, and a flight controller that controls flight based on the route information received by the route information reception unit.

### Advantageous Effects of Invention

According to the present invention, it is possible to provide an operation control apparatus, an operation control method, and an operation control system that can implement safe and efficient transport and logistics by coordination of a small flying object with a vehicle managed by another company and a ground vehicle for a public transport institution or the like. Particularly, it is possible to provide a flight operation control apparatus, an operation control method, and an operation control system that can appropriately transport a person and a cargo from an alternative site to a destination by coordination with a ground vehicle in a case where it is difficult to arrive at a destination due to some cause during flight of a flying object.

### BRIEF DESCRIPTION OF DRAWINGS

FIG. 1 is a conceptual diagram of a situation in which an operation control apparatus according to a first embodiment is used.

FIG. 2 is a schematic configuration diagram of the operation control apparatus according to the first embodiment.

FIG. 3 is a schematic configuration diagram of a small flying object according to the first embodiment.

FIG. 4 is a schematic configuration diagram of an operation control apparatus side system and a small flying object side system according to the first embodiment.

FIG. 5A is a diagram illustrating an example of data registered in a site table.

FIG. 5B is a diagram illustrating an example of data registered in a flight operation plan table.

FIG. 5C is a diagram illustrating an example of data registered in a business partner table.

FIG. 6 is a conceptual diagram of transfer in a case where a passenger and a cargo are transferred to a destination from an alternative landing site to a ground vehicle.

FIG. 7 is a conceptual diagram of transfer in a case where a passenger is transferred to a destination from an alternative landing site to a railway vehicle.

FIG. 8A is a diagram illustrating a problem code table stored in storage of the operation control apparatus and storage of the small flying object.

FIG. 8B is a diagram illustrating a processing ID table stored in the storage of the operation control apparatus and the storage of the small flying object.

FIG. 9 is a flowchart of an operation of a transfer determining unit.

FIG. 10 is a flowchart illustrating details of step S904 illustrated in FIG. 9.

FIG. 11 is a flowchart illustrating details of step S1004 illustrated in FIG. 10.

FIG. 12 is a flowchart illustrating details of step S1005 illustrated in FIG. 10.

FIG. 13 is a flowchart illustrating details of step S1006 illustrated in FIG. 10.

FIG. 14 is a flowchart of an operation of the small flying object side system.

FIG. 15A is an explanatory diagram of an overall data format transmitted from the small flying object to the operation control apparatus.

FIG. 15B is an explanatory diagram of a data format of visibility levels transmitted from the small flying object to the operation control apparatus.

FIG. 16 is a flowchart of an operation of an environment prediction unit of the operation control apparatus.

FIG. 17 is a flowchart of an operation of searching for a candidate landing site by the transfer determining unit of the operation control apparatus.

FIG. 18 is a diagram illustrating a display example of a display screen of an input device.

### DESCRIPTION OF EMBODIMENTS

Hereinafter, embodiments of the present invention will be described with reference to the drawings. Various components of the present invention do not necessarily have to be independent entities, and it is permitted that one component include a plurality of members, that multiple components are made up of one member, that one component is a part of another component, and that a part of one component overlaps with a part of another component.

### First Embodiment

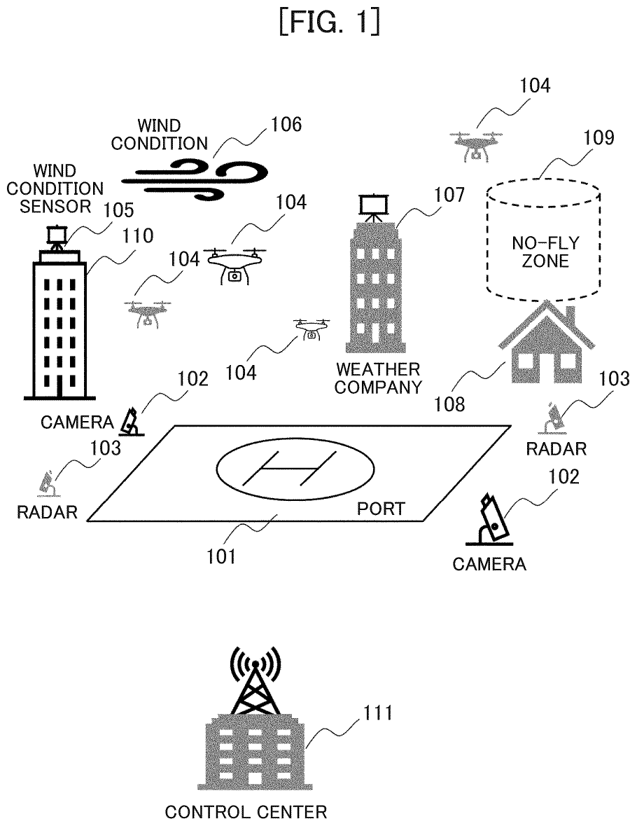

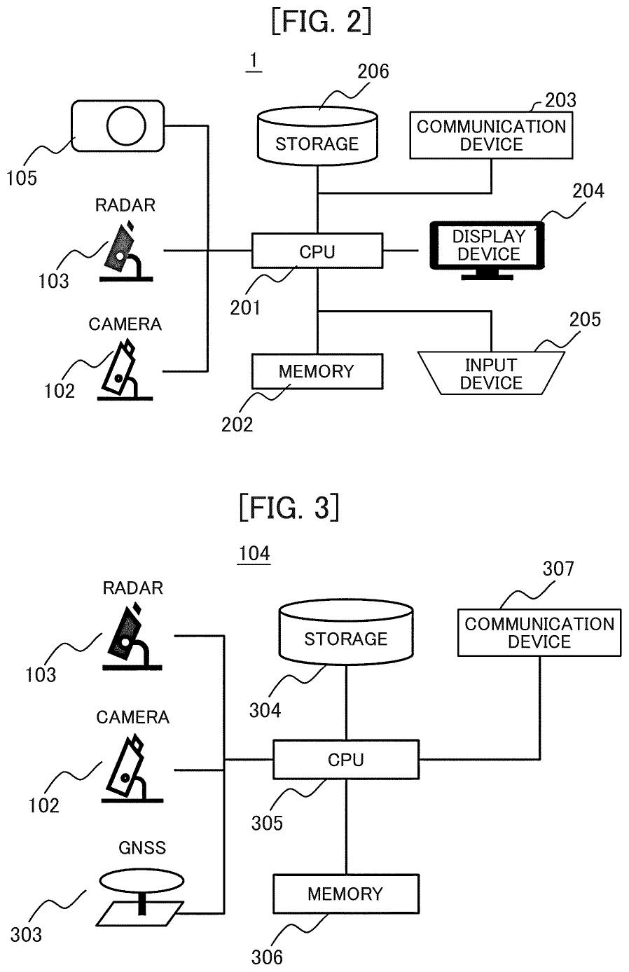

In a first embodiment, an example is described in which a flight operation control apparatus determines an alternative landing site for a flying object and a ground vehicle for transporting a subject carried by the flying object. FIG. 1 is a conceptual diagram of a situation in which an operation control apparatus 1 (illustrated in FIG. 2) according to the embodiment of the present invention is used. In FIG. 1, a small flying object 104 takes off and lands on a takeoff and landing port 101. A camera 102 and a radar 103 detect an environment surrounding the small flying object 104 and the takeoff and landing port 101 and transmits the detected environment to the operation control apparatus 1 in a control center 111. A wind condition sensor 105 installed in a building 110 detects a wind condition 106 in the vicinity of the takeoff and landing port 101 and transmits the wind condition 106 to the operation control apparatus 1. As the wind condition sensor 105, a Doppler Lidar can be used.

Weather information provided by a weather company 107 can be grasped by the operation control apparatus 1. The small flying object 104 determines a flight route based on information from a sensor installed in the small flying object 104, a map, the operation control apparatus 1, and the like.

FIG. 2 is a schematic configuration diagram of the operation control apparatus 1.

In FIG. 2, the operation control apparatus 1 includes a controller (CPU) 201, a memory 202, a communication device 203, a display device 204, and an input device 205. The controller 201 is connected to the memory 202, the communication device 203, the display device 204, and the input device 205.

In addition, the controller 201 is connected to the camera 102, the radar 103, and the wind condition sensor 105.

The controller 201 communicates information with the small flying object 104 via the communication device 203. In addition, the controller 201 receives information from the weather company 107 via the communication device 203.

FIG. 3 is a schematic configuration diagram of the small flying object 104.

In FIG. 3, the small flying object 104 includes a controller (CPU) 305, a memory 306, a communication device 307, and storage 304. The controller 305 is connected to the memory 306, the communication device 307, and the storage 304.

In addition, the controller 305 is connected to the camera 103, the radar 102, and a global navigation satellite system (GNSS) 303. The controller 305 communicates information with the operation control apparatus 1 via the communication device 307. In addition, the controller 305 receives information from the weather company 107 via the communication device 307. The communication device 307 includes a function of notifying information regarding the occurrence of a problem with the airframe, a passenger, and a cargo, or the like of the small flying object 104. The problem is, for example, an event such as an incident, an accident, bad weather, equipment trouble, or the like that adversely affects the flight operation or takeoff and landing of the small flying object 104, or the transport of the carried subject.

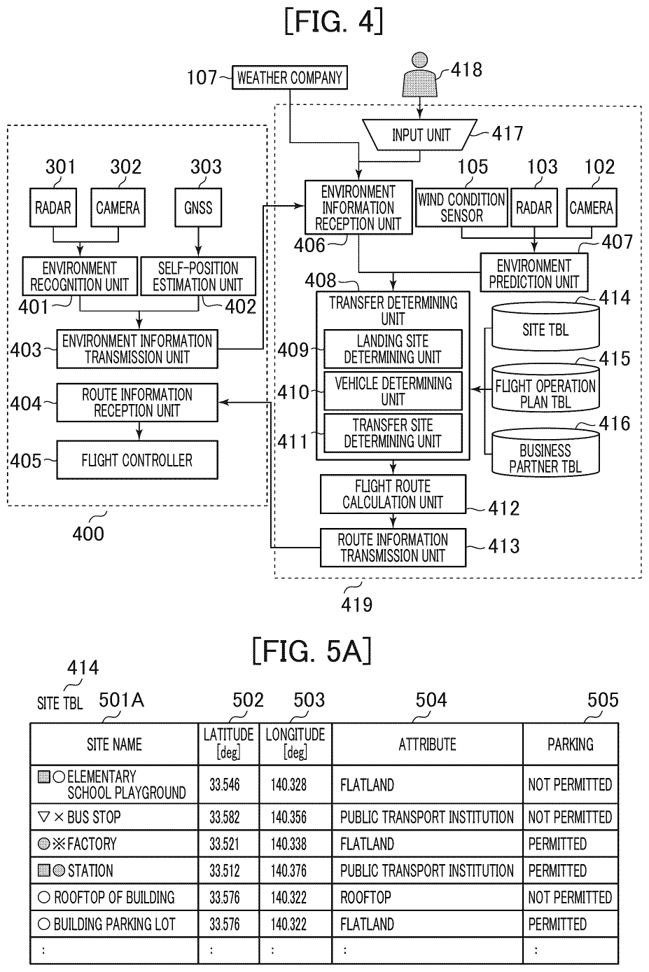

FIG. 4 is an explanatory diagram of functions in a small flying object side system 401 and an operation control apparatus side system 419.

In FIG. 4, the small flying object side system 400 includes an environment recognition unit 401 that recognizes an environment surrounding the small flying object 104 based on information from the radar 301 and the camera 302, a self-position estimation unit 402 that estimates a self-position of the small flying object 104 based on information from the GNSS 303, and an environment information transmission unit 403 that transmits, to the operation control apparatus side system 419, information from the environment recognition unit 401 and the self-position estimation unit 402.

In addition, the small flying object side system 400 includes a route information reception unit 404 that receives route information transmitted from the operation control apparatus side system 419, and a flight controller 405 that controls flight based on the route information transmitted from the route information reception unit 404.

The environment recognition unit 401, the self-position estimation unit 402, the environment information transmission unit 403, the route information reception unit 404, and the flight controller 405 correspond to functions in the controller 305 in the small flying object 104.

The operation control apparatus side system 419 includes an input unit 417 that inputs an instruction or the like of an operator 418, and an environment information reception unit 406. The environment information reception unit 406 receives information from the input unit 417, weather information from the weather company 107, and information from the environment information transmission unit 403 described above. The input unit 417 is included in the input device 205 of the operation control apparatus 1 illustrated in FIG. 2. In addition, the environment information reception unit 406 is included in the communication device 203.

If a problem such as an incident, an accident, or another event that cannot be obtained by the weather company 107 or the wind condition sensor 105 occurs, the operator 418 inputs information regarding the problem to the environment information reception unit 406 via the input unit 417. In addition, the information regarding the problem may be automatically acquired from a network or the like without the input by the operator 418 and may be received by the input unit 417.

In addition, the operation control apparatus side system 419 includes an environment prediction unit 407 that predicts an environment based on information from the wind condition sensor 105, the radar 103, and the camera 102, and a transfer determining unit 408 to which information from the environment prediction unit 407 and information from the environment information reception unit 406 are supplied.

The transfer determining unit 408 includes a landing site determining unit 409 that determines an alternative landing site based on information of a site table 414, a flight operation plan table 415 and a business partner table 416, a vehicle determining unit 410 that determines a transfer vehicle, and a transfer site determining unit 411 that determines a transfer site.

Further, the operation control apparatus side system 419 includes a flight route calculation unit 412 that calculates a flight route of the small flying object 104 based on information from the transfer determining unit 408, and a route information transmission unit 413 that transmits flight route information calculated by the flight route calculation unit 412 to the route information reception unit 404.

The site table 414, the flight operation plan table 415, and the business partner table 416 are stored in the storage 206 of the operation control apparatus 1.

In addition, the environment prediction unit 407, the environment information reception unit 406, and the flight route calculation unit 412 are included in the controller 201 of the operation control apparatus 1. The route information transmission unit 413 is included in the communication device 203 of the operation control apparatus 1.

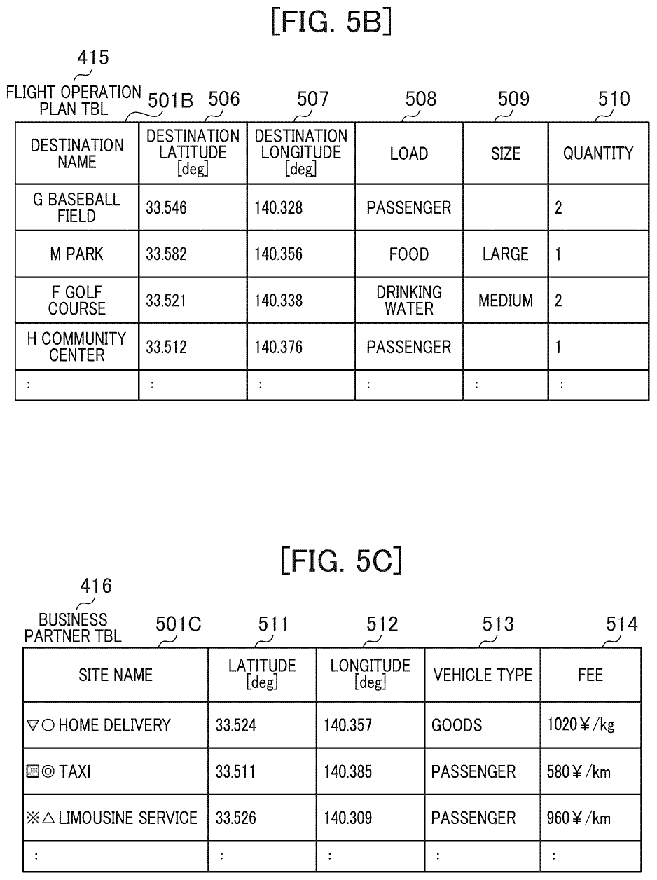

FIG. 5A is a diagram illustrating an example of data registered in the site table 414. In the site table 414, a latitude 502, a longitude 503, an attribute 504 of an alternative landing site and a transfer site, and information 505 indicating whether a ground vehicle is permitted to be parked are registered for each site name 501A that is a candidate for an alternative landing site and a transfer site.

FIG. 5B is a diagram illustrating an example of data registered in the flight operation plan table 415. In the flight operation plan table 415, a destination name 501B, a destination latitude 506, a destination longitude 507, a load 508 indicating an attribute of a subject to be carried, a size 509 and a quantity 510 of the subject to be carried are registered for each flight operation plan for the small flying object 104.

FIG. 5C is a diagram illustrating an example of data registered in the business partner table 416. In the business partner table 416, a latitude 511, a longitude 512, a vehicle type 513 of a ground vehicle at a transfer destination, and a fee 514 are registered for each site name 501C of a candidate transfer destination.

In the vehicle type 513, a vehicle type suitable for transport of goods, a passenger, and other cargo is defined.

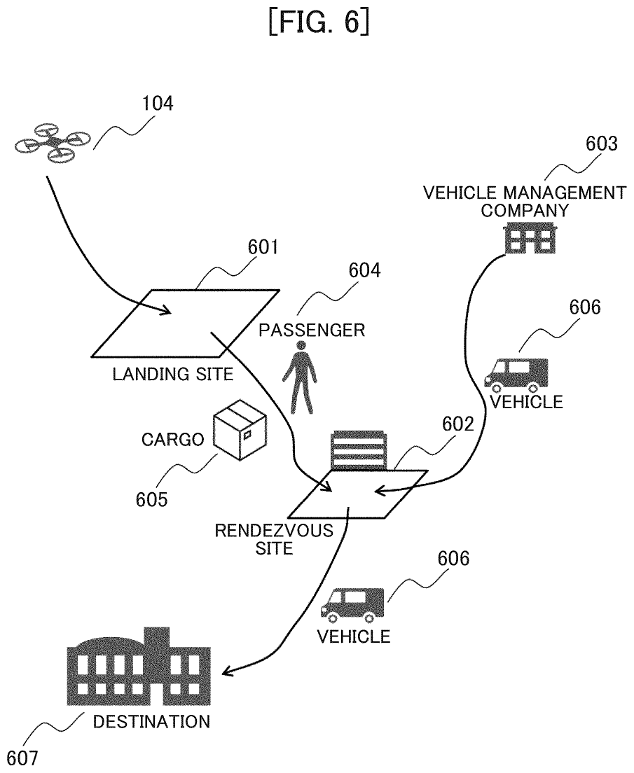

FIG. 6 is a conceptual diagram of transfer in a case where a passenger and a cargo are transferred to a destination from an alternative landing site to a ground vehicle.

In FIG. 6, when a problem regarding flight operation of the small flying object 104 occurs, the small flying object 104 lands on a landing site 601 (alternative landing site) determined by the transfer determining unit 408 of the flight operation apparatus side system 419, and subjects to be carried, such as a passenger 604 and a cargo 605 are moved from the landing site 601 to a rendezvous site (transfer site) 602 determined by the transfer determining unit 408 of the flight operation control apparatus side system 419. The passenger is notified in advance by a display device or a broadcast device in the small flying object 104 that a problem has occurred and that the passenger needs to move from the landing site 601 to the rendezvous site 602.

A vehicle management company 603 moves a vehicle 606 determined by the transfer determining unit 408 of the flight operation control apparatus side system 419 to the rendezvous site 602. When the vehicle 606 is permitted to be parked in the landing site 601, the landing site 601 may be set as the rendezvous site 602.

The vehicle 606 loads the passenger 604 and the cargo 605 in the rendezvous site 602 and is moved to a destination 607.

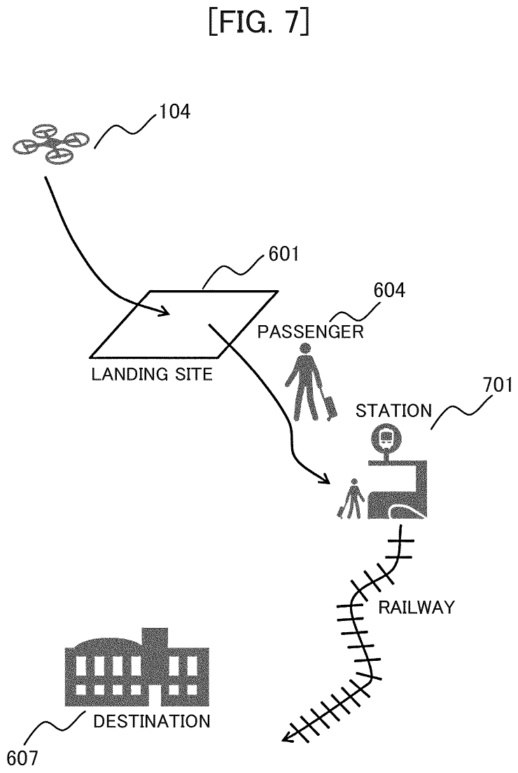

FIG. 7 is a conceptual diagram of transfer in a case where a passenger is transferred to a destination from an alternative landing site to a ground vehicle.

In FIG. 7, when a problem regarding flight operation of the small flying object 104 occurs, the small flying object 104 lands on the landing site 601 determined by the transfer determining unit 408 of the flight operation control apparatus side system 419, and the passenger 604 moves to a railway station 701 (transfer site) determined by the transfer determining unit 408 of the flight operation control apparatus side system 419. The passenger 604 moves from the station 701 to the destination 607 by a railway vehicle. In this case, the transfer destination is not limited to a railway and may be set as another public transport institution such as a bus.

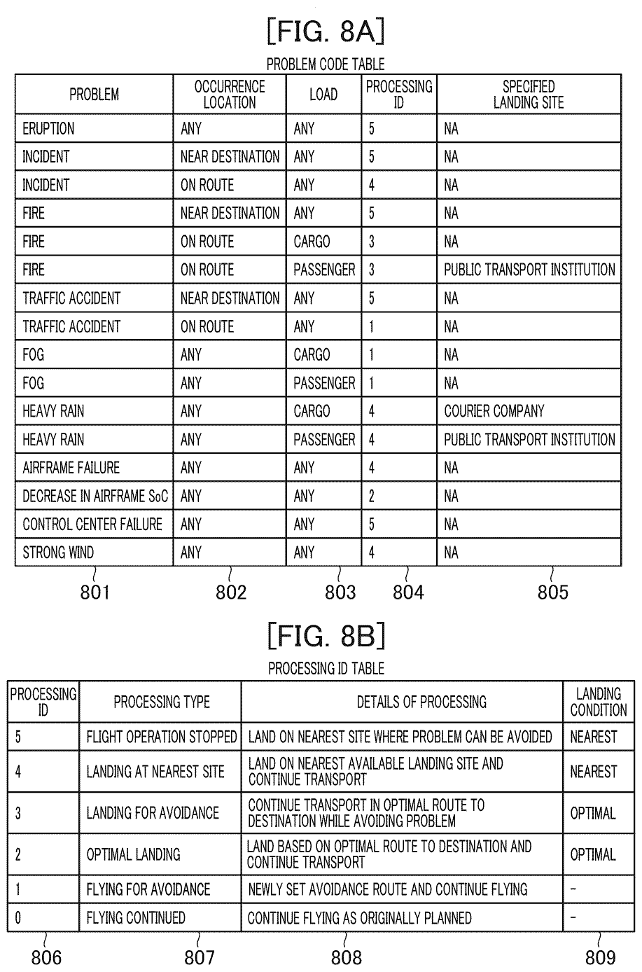

FIG. 8A is a diagram illustrating a problem code table stored in the storage 206 of the operation control apparatus 1 and the storage 304 of the small flying object 104. The flight operation of the small flying object 104 is determined in accordance with the content registered in the problem code table 8A.

In FIG. 8A, a location 802 where a problem has occurred, a load 803 of the small flying object 104, a processing ID 804, and an instructed landing site 805 are set for each problem 801 indicating a type of incident, accident, or the like. In FIG. 8A, “Any” means that there is no restriction on a subject, and “NA” means that there is no restriction on a specified landing site. Types of problems in FIG. 8A are one example, and the problems are not limited thereto as long as the these are events that interfere with the flight operation or takeoff and landing of the small flying object 104, or transport of a subject carried by the small flying object 104.

If a problem has occurred, processing varies depending on the type of the problem, a location where the problem has occurred, and the type of a load of the small flying object 104. In FIGS. 8A and 8B, the processing IDs 804 and 806 indicate a degree of urgency of a problem. As the degree of urgency is higher, the small flying corps 104 needs to land earlier.

Information of incidents, fires, and accidents among problems is not necessarily automatically input to the operation control apparatus 1, and thus the operator 418 of the flight operation control apparatus 1 may manually enter the information from the input device 205. If the problem is weather information, information of the wind condition sensor 105, the camera 103, and the weather company 107 can be used.

FIG. 8B is a diagram illustrating a processing ID table stored in the storage 206 of the operation control apparatus 1 and the storage 304 of the small flying object 104. In the processing ID table, a processing type 807 for a problem, a processing detail 808, and a landing condition 809 are set for each processing ID 806 indicating a degree of urgency of the problem.

If the problem is eruption, nobody knows where or what kind of disaster will occur, and thus the processing ID is 5, the flight operation is stopped, and the processing detail indicates “landing at the nearest problem avoidance location”.

If the problem is an incident or a fire and has occurred in the vicinity of a destination, the small flying object cannot approach the destination, the processing ID is 5, and the flight operation is stopped. However, if a fire occurs while a passenger is on board in the middle of a route, the processing ID is 3, and the small flying object lands near a public transport institution (station) with the aim of evacuating the passenger to a safe location.

If the problem is a traffic accident and has occurred near a destination, and there is a possibility that a cordon is in place, the processing ID is 5, and the flight operation is stopped. If the problem has occurred in the middle of a route, the processing ID is 3, and the small flying object continues flying in an avoidance route when a no-fly zone is set. After the avoidance, if the aircraft SoC (charge capacity of the airframe) decreases, the airframe will be processed in the same manner as for a decrease in the aircraft Soc.

If the problem is fog, the processing ID is 1, and the flying object continues flying in an avoidance route. After the flight in the avoidance route, if the aircraft SoC decreases, the airframe will be processed in the same manner as for a decrease in the aircraft Soc.

If the problem is heavy rain, there is a risk that the airframe of the flying object may drop, and thus the processing ID is 4, and the small flying object lands on the nearest landing site. However, in order to protect a cargo and a passenger, if a cargo is loaded on the small flying object, the small flying object will land near a delivery company, and if a passenger is loaded on the small flying object, the small flying object will land near a public transport institution (railway station).

If the problem is a failure of the airframe of the small flying object, it is dangerous to fly more, and thus the processing ID is 4 and the small flying object will land on the nearest available landing site.

If the problem is a decrease in the aircraft Soc, the processing ID is 2 and the small flying object lands based on an optimal route to the destination.

If the problem is a failure in the control center, it is dangerous to continue the flight operation, and thus the processing ID is 5 and the flight operation is stopped.

If the problem is a strong wind, it is dangerous to continue the flight, and thus the processing ID is 4 and the small flying object lands at the nearest location.

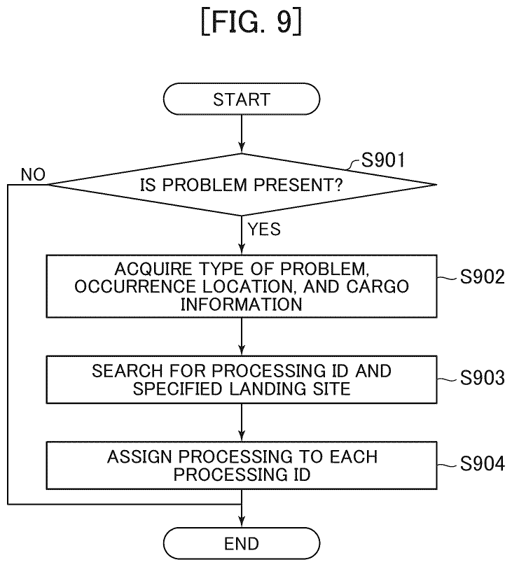

FIG. 9 is a flowchart of an operation of the transfer determining unit 408.

In step S901 illustrated in FIG. 9, the transfer determining unit 408 receives information from the environment information reception unit 406 or the environment prediction unit 407 and determines whether a problem is present. If the problem is not present, the process ends. If the problem is present, the process proceeds to step S902.

In step S902, the transfer determining unit 408 acquires the type of the problem, a location where the problem has occurred, and load information.

Next, in step S903, the transfer determining unit 408 searches for a processing ID and a specified landing site associated with the acquired problem information from the problem code table 8A stored in the storage 206.

Then, in step S904, the transfer determining unit 408 assigns processing to each processing ID.

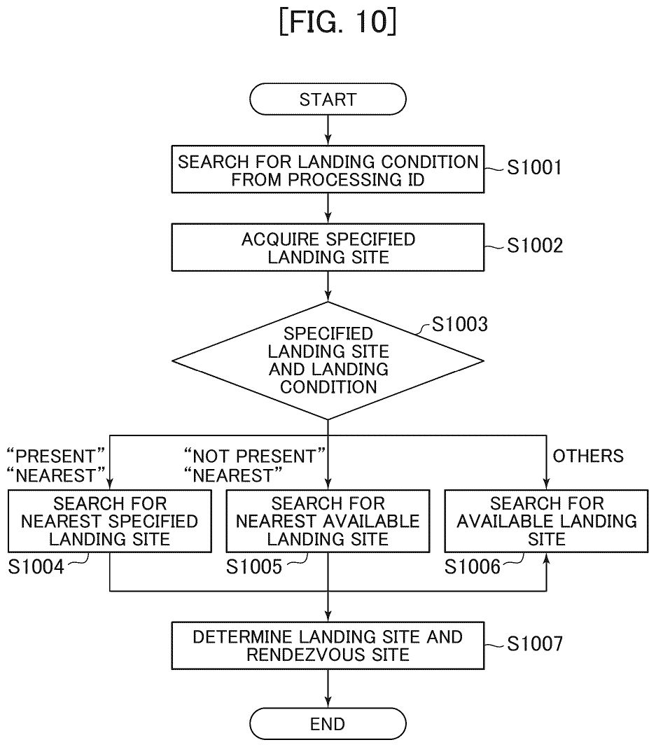

FIG. 10 is a flowchart illustrating details of step S904 illustrated in FIG. 9.

In step S1001 illustrated in FIG. 10, the transfer determining unit 408 searches for a landing condition from the processing ID table 8B stored in the storage 206 by using the processing ID as a key. Next, the process proceeds to step S1002, a landing site of the landing condition searched in step S1001 is acquired from the problem code table 8A stored in the storage 206.

Next, in step S1003, the transfer determining unit 408 branches the process based on the acquired specified landing site and the landing condition. If the specified landing site is present and the landing condition is the nearest specified landing site in step S1003, the process proceeds to step S1004, and the nearest specified landing site is searched from the site table 414. If the specified landing site is not present and the landing condition is the nearest available landing site in step S1003, the process proceeds to step S1005 and the nearest available landing site is searched from the site table 414. If the processing type is another type (the processing type is avoidance flight or continuing flight) in step S1003, the process proceeds to step S1006 and an available landing site is searched from the site table 414.

After the processing in step S1004, S1005, or S1006, the process proceeds to step S1007 and the transfer determining unit 408 determines a landing site and a rendezvous site.

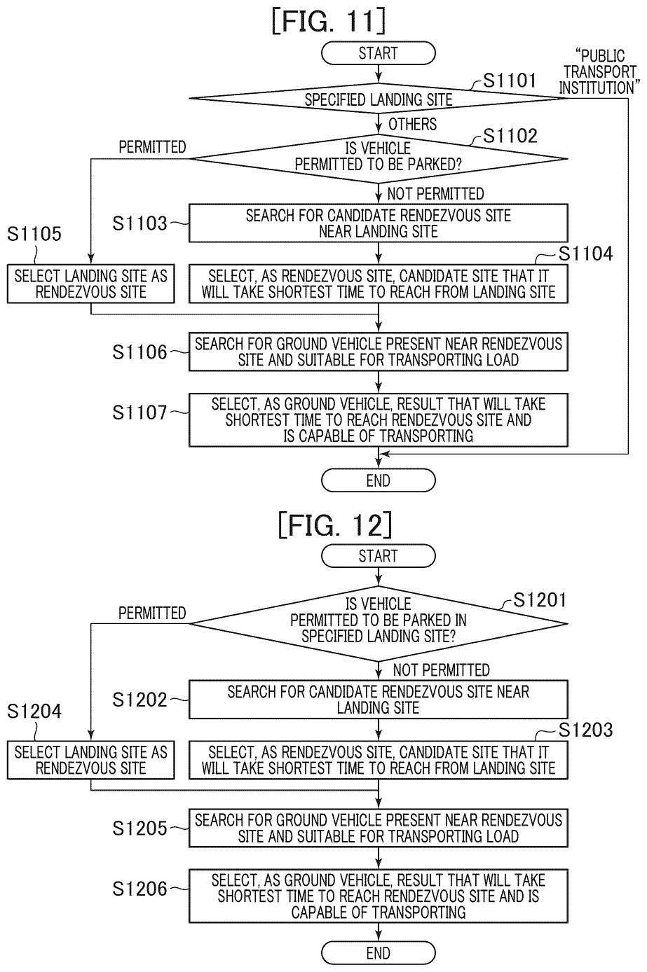

FIG. 11 is a flowchart illustrating details of step S1004 illustrated in FIG. 10.

If the specified landing site is present and the landing condition is the nearest specified landing site, the transfer determining unit 408 determines whether the attribute 504 of the nearest specified landing site searched from the site table 414 in step S1004 is a public institution in step S1101 illustrated in FIG. 11. If the attribute is the public institution, the process is ended. If the attribute is not the public institution and is another attribute, the process proceeds to step S1102.

In step S1102, the transfer determining unit 408 determines whether a ground vehicle is permitted to be parked in the nearest specified landing site searched from the site table 414 in step S1004. If the ground vehicle is permitted to be parked, the process proceeds to step S1105 and the landing site is selected as a rendezvous site. After the processing in S1105, the process proceeds to step S1106.

If the ground vehicle is not permitted to be parked in the nearest specified landing site searched from the site table 414 in step S1004, the process proceeds to step S1103, and the transfer determining unit 408 searches for, from the site table 414, a candidate rendezvous site that is near the specified landing site and in which the ground vehicle is permitted to be parked in step S1102. Then, the process proceeds to S1104.

In step S1104, the transfer determining unit 408 selects, as a rendezvous site from among the candidate searched in step S1103, a candidate that it will take the shortest time to reach from the specified landing site. Then, the process proceeds to step S1106.

In step S1106, the transfer determining unit 408 refers to the candidate selected in step S1104 and the flight operation plan table 415 for the small flying object 104, searches for a ground vehicle present near a rendezvous site and suitable for transporting the load of the small flying object 104 from the business partner table 416, and selects, as a ground vehicle, a result that will take the shortest time to reach the rendezvous site and is capable of transporting the load in step S1107.

FIG. 12 is a flowchart illustrating details of the processing in step S1005, which is illustrated in FIG. 10, in which the specified landing site is not present and the landing condition is the nearest available landing site.

In step S1201 illustrated in FIG. 12, the transfer determining unit 408 determines whether the ground vehicle is permitted to be parked in the nearest available landing site searched from the site table 414 in step S1005. If the ground vehicle is permitted to be parked, the process proceeds to step S1204, and the landing site is selected as the rendezvous site. After the processing in step S1204, the process proceeds to step S1205.

If the ground vehicle is not permitted to be parked in the nearest available landing site searched from the site table 414 in step S1005, in step S1201, the process proceeds to step S1202, and the transfer determining unit 408 searches for, from the site table 414, a candidate rendezvous site that is in the vicinity of the available landing site and in which the ground vehicle is permitted to be parked. Then, the process proceeds to step S1203.

In step S1203, the transfer determining unit 408 selects, as the rendezvous site, a candidate that it will take the shortest time to reach from the available landing site among the candidates searched in step S1202. Then, the process proceeds to step S1205.

In step S1205, the transfer determining unit 408 refers to the candidate selected in step S1203 and the flight operation plan table 415 for the small flying object 104, and searches for a ground vehicle present near the rendezvous site and suitable for transporting a load carried by the small flying object 104 from the business partner table 416.

In step S1206, the transfer determining unit 408 selects, as a ground vehicle, a result that will take the shortest time to reach the rendezvous site and is capable of transporting the load.

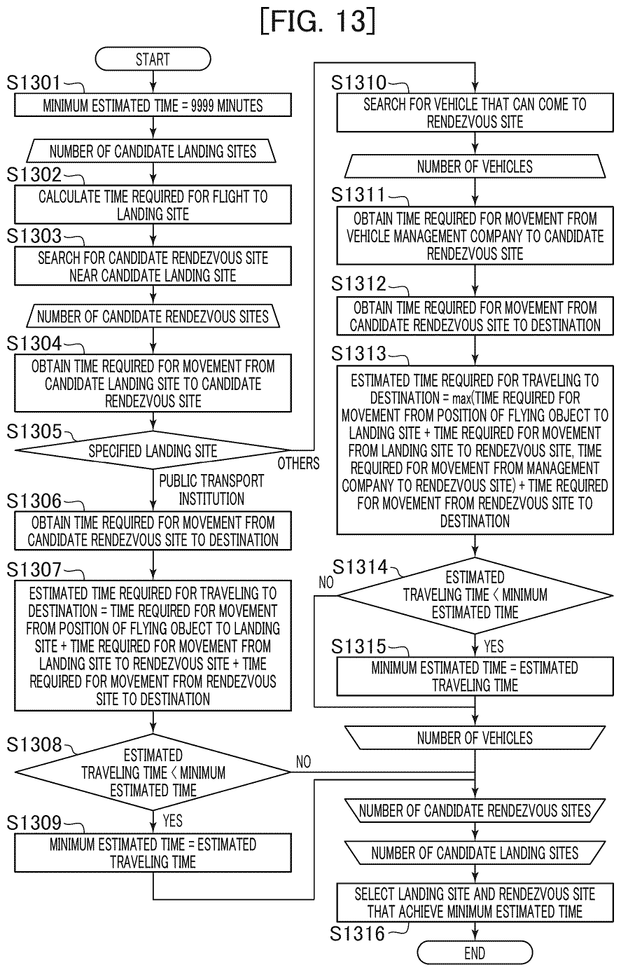

FIG. 13 is a flowchart illustrating details of step S1006 illustrated in FIG. 10.

If the small flying object does not need to land on the nearest site, the transfer determining unit 408 sets an initial time of the minimum estimated time in step S1301 illustrated in FIG. 13. Although 9999 minutes are illustrated in the example in the drawing, the minimum estimated time can be set to any value up to the maximum possible time.

Next, in step S1302, the transfer determining unit 408 calculates a time required for flight to the landing site based on information of the environment information reception unit 406, the environment prediction unit 407, and the flight operation plan table 415 for the small flying object 104. In step S1303, the transfer determining unit 408 searches for a candidate rendezvous site near a candidate landing site from the site table 414. Then, in step S1304, the transfer determining unit 408 refers to the site table 414 and obtains a time required for movement from the candidate landing site to the candidate rendezvous site. In step S1305, the transfer determining unit 408 refers to the site table 414 and determines whether the specified landing site is a public institution or another landing site.

In step S1305, if the specified landing site is the public institution, the process proceeds to step S1306, and if the specified landing site is the other landing site, the process proceeds to step S1310.

In step S1306, the transfer determining unit 408 obtains a time required for movement from the candidate rendezvous site to the destination based on information of the site table 414 and the flight operation plan table 415.

Next, in step S1307, the transfer determining unit 408 calculates an estimated time for traveling to the destination based on information of the environment information reception unit 406, the environment prediction unit 407, the site table 414, and the flight operation plan table 415. The estimated time for traveling to the destination is a time obtained by summing the time required for movement from the position of the small flying object 104 to the landing site, the time required for movement from the landing site to the rendezvous site, and the time required for movement from the rendezvous site to the destination.

Then, in step S1308, the transfer determining unit 408 determines whether the estimated traveling time is shorter than the minimum estimated time. If the estimated traveling time is shorter than the minimum estimated time, the process proceeds to step S1309, the minimum estimated time is treated as the estimated traveling time, the process loop for the number of vehicles is exited, and steps S1304 to S1315 are repeated for the number of candidate rendezvous sites.

If the estimated traveling time is longer than or equal to the minimum estimated time in step S1308, the process loop for the number of vehicles is exited, and steps S1304 to S1315 are repeated for the number of candidate rendezvous sites.

In step S1305, in a case where the specified landing site is not the public institution, the process proceeds to step S1310 and the transfer determining unit 408 searches for a vehicle that can come to the rendezvous site from the business partner table 416.

Then, in step S1311, the transfer determining unit 408 obtains a time required for movement from the vehicle management company 603 to the candidate rendezvous site based on information of the site table 414 and the business partner table 416. Next, in step S1312, the transfer determining unit 408 obtains a time required for movement from the candidate rendezvous site to the destination based on the information of the site table 414.

In step S1313, the transfer determining unit 408 calculates an estimated time for traveling to the destination based on information of the environment information reception unit 406, the environment prediction unit 407, the site table 414, the flight plan table 415, and the business partner table 416. The estimated time for traveling to the destination is max (the time required for movement from the position of the flying object to the landing site+the time required for movement from the landing site to the rendezvous site, the time required for movement from the vehicle management company 603 to the rendezvous site+the time required for movement from the rendezvous site to the destination). Note that max means the maximum value.

Next, in step S1314, the transfer determining unit 408 determines whether the estimated traveling time is shorter than the minimum estimated time. If the estimated traveling time is shorter than the minimum estimated time, the process proceeds to step S1315, the minimum estimated time is treated as the estimated traveling time, and if the estimated traveling time is not shorter than the minimum estimated time, the minimum estimated time remains. Then, steps S1311 to S1315 are repeated until the number of vehicles reaches a predetermined number of vehicles.

When the process loop for the predetermined number of vehicles is exited, steps S1302 to S1315 are repeated up to the number of candidate landing sites.

Then, when the process loop for the number of candidate landing sites is exited, the process proceeds to step S1316, the transfer determining unit 408 selects a landing site and a rendezvous site that achieve the minimum estimated time, and the process ends.

### Second Embodiment

In a second embodiment, an example in which the small flying object searches for a new candidate landing site is described.

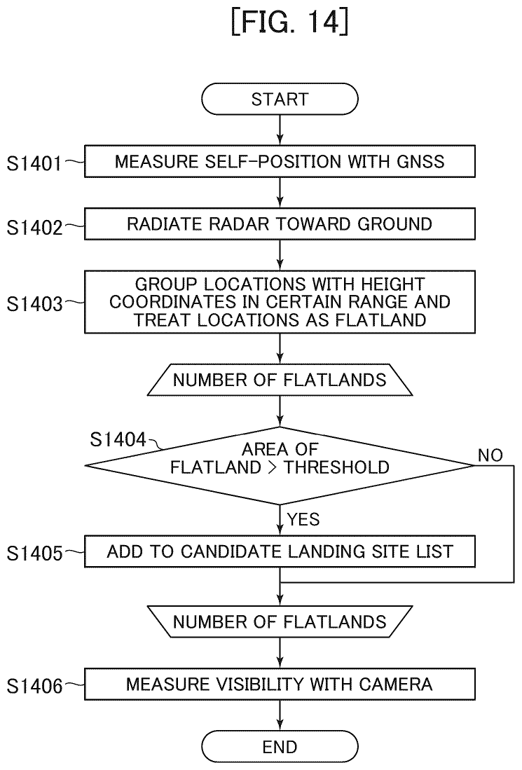

FIG. 14 is a flowchart of an operation of the small flying object side system 400.

In step S1401 illustrated in FIG. 14, the GNSS 303 of the small flying object 104 measures the self-position, and in step S1402, the radar 301 irradiates the ground.

In step S1403, the controller 305 of the small flying object 104 groups locations with height coordinates in a certain range on the ground measured in step S1402 and treats the locations as a flatland.

Then, in step S1404, the controller 305 determines whether the area of the flatland obtained in step S1403 is greater than a predetermined threshold. If the area is greater than the threshold, the controller 305 adds the flatland to candidate landing sites in step S1405.

If the area of the flatland obtained in step S1403 is less than or equal to the predetermined threshold, the controller 305 determines a next flatland in step S1404. Steps S1404 and S1405 are repeated until the number of flatlands reaches a predetermined number of flatlands.

In step S1406, the small flying object 104 measures visibility for the vicinity of flatlands of a predetermined number of candidate landing sites by using the camera 302.

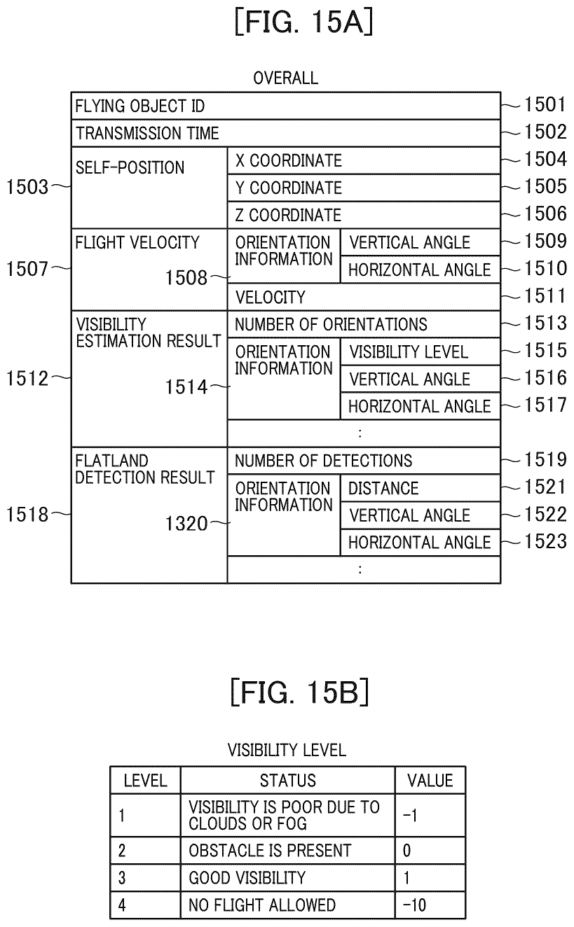

FIG. 15A is an explanatory diagram of an overall data format for a candidate landing site transmitted from the small flying object 104 to the operation control apparatus 1, and FIG. 15B is an explanatory diagram of a data format of visibility levels.

In FIG. 15A, the overall data format includes a flying object ID 1501, a transmission time 1502, a self-position 1503, a flight velocity 1507, a specifying estimation result 1512, and a flatland detection result 1518.

The self-position 1503 includes an X coordinate 1504, a Y coordinate 1505, and a Z coordinate 1506. The flight velocity 1507 includes orientation information 1508 and a velocity 1511. The orientation information 1508 includes a vertical angle 1509 and a horizontal angle 1510.

The visibility estimation result 1512 includes a number of orientations 1513 and orientation information 1514. The orientation information 1514 includes a visibility level 1515, a vertical angle 1516, and a horizontal angle 1517.

The flatland detection result 1518 includes a number of detections 1519 and orientation information 1320. The orientation information 1320 includes a distance 1521, a vertical angle 1522, and a horizontal angle 1523.

In FIG. 15B, the visibility levels are four levels which are 1, 2, 3, and 4, and a status of level 1 is that “the visibility is poor due to clouds or fog”, and the value is −1. A status of level 2 is that “an obstacle is present”, and the value is 0. A status of level 3 is that “the visibility is good”, and the value is 1. A status of level 4 is that “flight is prohibited”, and the value is −10.

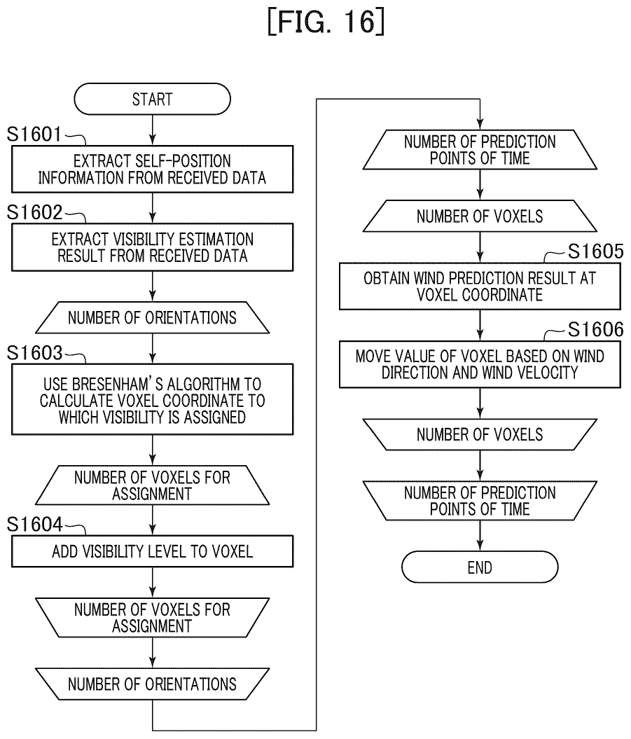

FIG. 16 is a flowchart of an operation of the environment prediction unit 407 of the operation control apparatus 1.

In step S1601 illustrated in FIG. 16, the environment prediction unit 407 extracts self-position information from the data (FIG. 15A) received from the environment transmission unit 403 of the small flying object 104, and in step S1602, the environment prediction unit 407 extracts the visibility estimation result from the received data (FIG. 15A).

In step S1603, the environment prediction unit 407 uses a Bresenham's line algorithm based on the self-position information to calculate a voxel coordinate to which visibility is assigned. Next, in step S1604, the environment prediction unit 407 adds a value corresponding to a visibility level to the voxel value to which the visibility has been assigned in step S1603 based on the visibility estimation result. The operation in step S1604 is repeated for the number of voxels for assignment. Then, the operations in steps S1603 and S1604 are repeated for the number of orientations.

Next, in step S1605, the environment prediction unit 407 acquires, from the wind condition sensor 105 or the environment information reception unit 406, a wind prediction result for the voxel coordinate to which the value of the visibility level has been added in step S1604, and in step S1606, the environment prediction unit 407 moves the voxel value based on a wind orientation and a wind velocity. The operations in step S1605 and S1606 are repeated for the number of voxels. In addition, the operations in steps S1605 and S1606 are repeated for number of prediction points of time. Then, the process ends.

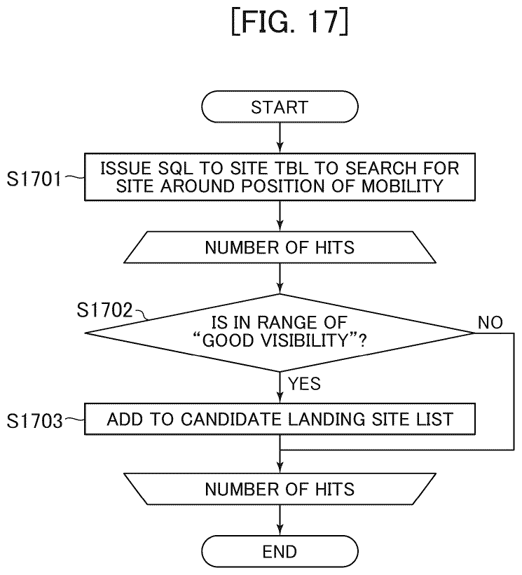

FIG. 17 is a flowchart of an operation of searching for a candidate landing site by the transfer determining unit 408 of the operation control apparatus 1.

In step S1701 illustrated in FIG. 17, the transfer determining unit 408 issues SQL (database language) to the site table 414 to search for a site around the position of the small flying object 104. Next, in step S1701, the transfer determining unit 408 determines whether a candidate landing site calculated by the environment prediction unit 407 is in a range of “good visibility”, and if the candidate landing site is in the range of “good visibility”, the process proceeds to step S1703 and the transfer determining unit 408 adds the candidate landing site to a candidate landing site list. Then, steps S1702 and S1703 are repeated for the number of hits. In step S1702, in a case where the candidate landing site is not in the range of “good visibility”, steps S1702 and S1703 are repeated up to the number of hits.

### Third Embodiment

In a third embodiment, an example regarding the input device 205 of the operation control apparatus 1 is described.

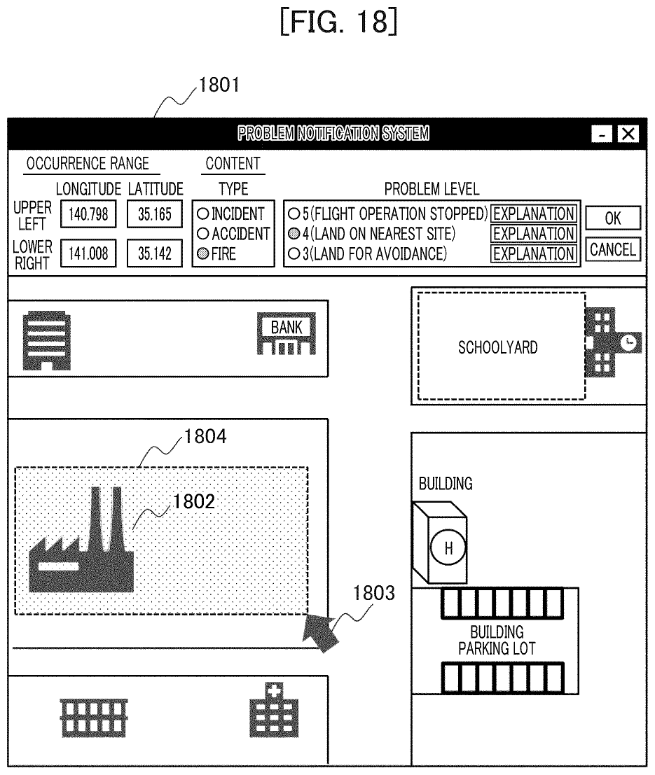

FIG. 18 is a diagram illustrating a display example of an input screen 1801 of the input device 205.

The example illustrated in FIG. 18 is an example of a screen for the operator 418 to input a problem, and the scope of the problem, the type of the problem, and the level of the problem are displayed. A mouse pointer 1803 can be used to specify and input a range 1804 in which a problem has occurred (in the illustrated example, a fire in a factory 1802).

### Other Examples

In the example described above, it may be considered that a vehicle that will take over the movement of the passenger 604 and the cargo 605 to the destination cannot be detected, or that it takes time to detect the vehicle, resulting in a delay in detection. In this case, it may be configured to select whether the small flying object hovers over a transfer site and waits or lands on another alternative site and waits, and communicate with the small flying object 104.

In the example described above, the present invention is not limited to the small flying object 104 and is applicable to a flying object other than small flying objects.

In addition, the carried subject is a general term for a passenger and a cargo.

### LIST OF REFERENCE SIGNS

1: operation control apparatus
101: takeoff and landing port
102: camera
103: radar
104: small flying object
105: wind condition sensor
106: wind condition
107: weather company
108: house
109: no-fly zone
110: building
111: control center
201: controller (CPU)
202: memory
203: communication device
204: display device
205: input device
303: global navigation satellite system (GNSS)
304: storage
305: controller (CPU)
306: memory
400: small flying object side system
401: environment recognition unit
402: self-position estimation unit
403: environment information transmission unit
404: route information reception unit
405: flight controller
406: environment information reception unit
407: environment prediction unit
408: transfer determining unit
409: landing site determining unit
410: vehicle determining unit
411: transfer site determining unit
412: flight route calculation unit
413: route information transmission unit
414: site table
415: flight operation plan table
416: business partner table
417: input unit
418: operator
419: operation control apparatus side system
601: landing site
602: rendezvous site
603: vehicle management company
604: passenger
605: cargo
606: vehicle
607: destination
701: station
1801: display screen
1802: factory
1803: mouse pointer
1804: specified range

1. An operation control apparatus comprising
a transfer determining unit that determines an alternative landing site and a ground vehicle for transporting a subject carried by a flying object from the alternative landing site to a destination,
based on self-location information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination.

2. The operation control apparatus according to claim 1, wherein
the site information includes information of a candidate for a transfer site for transfer from the alternative landing site to the ground vehicle, and
the transfer determining unit determines the alternative landing site, the transfer site, and the ground vehicle for transporting the subject carried by the flying object from the transfer site to the destination.

3. The operation control apparatus according to claim 2, further comprising
an environment information reception unit that receives problem information including information regarding a type of an event that causes a problem with the flight operation of the flying object or the transport of the carried subject, and a location where the problem has occurred, wherein
the transfer determining unit determines, based on the problem information, a degree of urgency of the problem and a condition for the alternative landing site, and
determines the alternative landing site, the transfer site, and the ground vehicle for transporting the subject carried by the flying object from the transfer site to the destination.

4. The operation control apparatus according to claim 3, wherein
the site information includes information regarding whether the candidate for the transfer site corresponds to a public transport institution, and
if the specified landing site is the public transport institution, the transfer determining unit determines the public transport institution for transporting the subject carried by the flying object to the alternative landing site and the destination based on the site information.

5. The operation control apparatus according to claim 2, wherein
the site information includes information indicating whether the ground vehicle is permitted to be parked in the candidate for the alternative landing site and the candidate for the transfer site,
if the ground vehicle is permitted to be parked in the candidate for the alternative landing site, the transfer determining unit determines the alternative landing site and the ground vehicle for transporting the subject carried by the flying object from the alternative landing site to the destination, and
if the ground vehicle is not permitted to be parked in the candidate for the alternative landing site, the transfer determining unit determines the alternative landing site, the transfer site where the ground vehicle is permitted to be parked, and the ground vehicle for transporting the subject carried by the flying object from the transfer site to the destination.

6. The operation control apparatus according to claim 1, wherein
the flying object includes
a flight route calculation unit that calculates a flight route for the flying object to land on the alternative landing site, and
a route information transmission unit that transmits the flight route to the flying object.

7. The operation control apparatus according to claim 1, wherein
the surrounding environment information includes flatland information obtained by measuring an area of a flatland surrounding the flying object, and visibility level information indicating a level of visibility, and
the transfer determining unit searches for a candidate for the alternative landing site based on the self-position information and the surrounding environment information.

8. An operation control method in which an operation control apparatus controls flight operation of a flying object, the operation control method comprising:
causing the operation control apparatus to determine an alternative landing site and a ground vehicle for transporting a subject carried by the flying object from the alternative landing site to a destination,
based on self-position information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination.

9. The operation control method according to claim 8, wherein
the site information includes information of a candidate for the transfer site for transfer from the alternative landing site to the ground vehicle, and
the operation control apparatus determines the transfer site, the alternative landing site, and the ground vehicle for transporting the subject carried by the flying object from the transfer site to the destination.

10. The operation control method according to claim 9, wherein
the operation control apparatus receives problem information including information regarding a type of an event that causes a problem with the flight operation of the flying object or the transport of the carried subject, and a location where the problem has occurred,
the operation control apparatus determines a degree of urgency of the problem and a condition for the alternative landing site based on the problem information, and
determines the alternative landing site, the transfer site, and the ground vehicle for transporting the subject carried by the flying object from the transfer site to the destination.

11. The operation control method according to claim 10, wherein
the site information includes information regarding whether the candidate for the transfer site corresponds to a public transport institution, and
if the specified landing site is the public transport institution, the operation control apparatus determines the public transport institution for transporting the subject carried by the flying object to the alternative landing site and the destination based on the site information.

12. The operation control method according to claim 8, wherein
the site information includes information indicating whether the ground vehicle is permitted to be parked in the candidate for the alternative landing site and the candidate for the transfer site,
in the operation control apparatus, if the ground vehicle is permitted to be parked in the candidate for the alternative landing site, the transfer determining unit determines the alternative landing site and the ground vehicle for transporting the subject carried by the flying object from the alternative landing site to the destination, and
if the ground vehicle is not permitted to be parked in the candidate for the alternative landing site, the transfer determining unit determines the alternative landing site, the transfer site where the ground vehicle is permitted to be parked, and the ground vehicle for transporting the subject carried by the flying object from the transfer site to the destination.

13. The operation control method according to claim 8, wherein
the operation control apparatus calculates a flight route for the flying object to land on the alternative landing site, and
the operation control apparatus transmits the flight route to the flying object.

14. The operation control method according to claim 8, wherein
the surrounding environment information includes flatland information obtained by measuring an area of a flatland surrounding the flying object, and visibility level information indicating a level of visibility, and
the operation control apparatus searches for the candidate for the alternative landing site based on the self-position information and the surrounding environment information.

15. An operation control system comprising:
an operation control apparatus including a transfer determining unit that determines an alternative landing site and a ground vehicle for transporting a subject carried by a flying object from the alternative landing site to a destination, based on self-position information of the flying object, surrounding environment information of the flying object, site information that is information of a candidate for the alternative landing site where the flying object lands, flight operation plan information to the destination of the flying object, and ground vehicle information that is information of a candidate for the ground vehicle at a transfer destination, a flight route calculation unit that calculates a flight route for the flying object to land on the alternative landing site, and a route information transmission unit that transmits the flight route to the flight object; and
a flying object including an environment information transmission unit that transmits the surrounding environment information to the operation control apparatus, a route information reception unit that receives flight route information from the operation control apparatus, and a flight controller that controls flight based on the route information received by the route information reception unit.
